(19) United States
(12) Patent Application Publication
(10) Pub. No.: US 2015/0139076 A1
(43) Pub. Date: May 21, 2015

(54) SERVICE PROVISION IN A CELLULAR COMMUNICATIONS NETWORK COMPRISING CELLS WITH DIFFERENT SERVICE CAPABILITIES

(71) Applicant: TELEFONAKTIEBOLAGET L M ERICSSON (PUBL), Stockholm (SE)

(72) Inventors: Ralf Keller, Wurselen (DE); Peter Hedman, Helsingborg (SE); Fredrik Lindholm, Stockholm (SE)

(73) Assignee: TELEFONAKTIEBOLAGET L M ERICSSON (PUBL), Stockholm (SE)

(21) Appl. No.: 14/398,563

(22) PCT Filed: May 14, 2013
(86) PCT No.: PCT/EP2013/059951

§ 371 Date: Nov. 3, 2014

Related U.S. Application Data
(60) Provisional application No. 61/646,555, filed on May 14, 2012.

(51) Int. Cl. H04W 48/18; H04W 60/04; H04W 8/02

(52) U.S. Cl. CPC H04W 48/18; H04W 8/02; H04W 60/04
USPC 370/328

(57) ABSTRACT

The invention refers to a method of providing a certain communication service with respect to a user equipment —UE (10) in a cellular communications network, the communications network comprising a radio access network—RAN-node (12) and a plurality of cells, wherein at least a first cell of the plurality of cells is capable of supporting the certain service, and at least a second of the plurality of cells is not capable of supporting the certain service, and a core network—CN-node (14) involved in a bearer activation process with respect to the UE (10), the radio access network node (12) performing receiving an information indicative of that the UE (10) requests the certain service, while the UE (10) is camping on the second cell, and initiating a movement to the first cell. The invention further refers to a radio access node (14), a computer program loadable into the radio access node.

### TECHNICAL FIELD

The invention generally refers to ensuring service provision, and specifically refers to mobility management and corresponding bearer setup.

### BACKGROUND

An area (e.g. Tracking Area or Routing Area) or a cellular communications network might have a plurality of cells having different capabilities with respect to specific communication services, e.g. some cells might use FDD (Frequency Division Duplexing) and some cells might use TDD (Time Division Duplexing). A part of the cells might not be able to support a certain service e.g. IP Multimedia Subsystem Packet Switched—IMS PS—Voice or IPTV for any reason. The reason may depend on network/technology related aspects causing the operator not wanting the technology to be used for a certain service, or it may depend on the user equipment—UE—ability to support the service with certain technology (e.g. UE been only tested to support IMS PS voice using FDD and not TDD) or it may depend on not supporting all required capabilities e.g. in TDD while having support for them in FDD (there might be in addition TDD-only cells from some vendors that do not provide support for IMS voice).

3GPP specifications TS 23.401, version 11.0.0 of December 2012 (in the following being referred to as TS 23.401) and TS 23.060, version 11.0.0 of December 2011 (in the following being referred to as TS 23.060) require the network support for IMS PS voice to be homogenous within a Tracking Area (list)—TA—or Routing Area—RA—. The reason is to ensure that the certain service e.g. IMS PS voice calls, will not experience large drop of calls or other service degradation and to allow that the UE does not have to perform TA update—TAU—or RA update—RAU—in the same Tracking Area (list) or Routing Area.

However, the expected deployments of e.g. so-called FEMTO cells or Home eNodeBs (H(e)NodeBs) within the same TA/RA as normal macro cells might cause issues with keeping the TA/RA homogenous with regards to support of IMS PS voice.

According to above-cited 3GPP specifications, a Tracking Area list or Routing Area shall be homogenous with regard to its support of IMS PS voice. Consequently, both FDD and TDD cells may not be included together in a Tracking Area list or Routing Area, when the UE supports IMS PS voice for either FDD or TDD only. This retains a possibility for the UE to use IMS PS voice in a mixed cell situation. To be able to support both Internet/broadband services and as well further services like IMS PS voice services to a UE, a new way to ensure consistent service support is desired.

### SUMMARY

It is an objective of the present invention to provide a possibility for enhancing a usage of communication services requiring capabilities that are provided by all cells the UE might camp. This objective is achieved by the following embodiments. Advantageous embodiments are described as follows.

According to embodiments it is proposed to provide a certain service (e.g. IMS PS voice instead of selecting the CS domain for voice or IPTV), despite the UE is camping on a cell which does not support that service.

Camping on a cell may comprise a state wherein the UE is in idle mode and has performed or completed a cell selection/reselection process and chosen a cell, as well as a state wherein the UE is connected or attached to that cell.

In an embodiment it is proposed to let appropriate entities know that a UE can be moved from a cell lacking the ability to support a certain service (e.g. IMS PS voice) to a cell which is able to support that certain service, allowing appropriate entities initiating the service despite the lack of capabilities or incompatibility with respect to the service of the current cell the UE is camping on.

In an embodiment thereto, during mobility management procedures (e.g. evolved packed core—EPC—mobility management—EMM—or GMM) procedures, the UE is getting information that the service is supported for a Tracking Area list or Routing Area (see e.g. IMS voice over PS Session Supported Indication according to above-cited 3GPP standards TS 23.060 and TS 23.401), despite that the UE cannot use that service in one or a plurality of the cells of the Tracking Area list or Routing Area (the later might be only known to the eNB/RNC).

In an embodiment, the eNB/RNC replies with a Successful Match message when receiving the UE Radio Capability Match Request from the mobility management node (MME or SGSN), despite that the UE capabilities are incompatible with network configuration for the one or the plurality of cells. When the core network CN requests a bearer (e.g. QCI-1 for eUTRAN, or traffic class set to conversational and source statistic descriptor set to ‘Speech for UTRAN) to be established, the eNB/RNC moves the UE to a cell (served by the same or different eNB/RNC) were the required capabilities associated to that service are supported. Such movement may be performed before, concurrently or after the bearer has been established.

In another embodiment, it is proposed to ensure that the UE is always kept on cells which are capable of supporting the certain service (e.g. IMS PS voice) that the UE requests. Thereto, a radio access network—RAN—node (eNB or RNC) might ensure (e.g. for one or a plurality of (selected) UEs only) to always camp on cells supporting that certain service.

A trigger for the RAN node to initiate such (RRM) strategy may be e.g. one of:
Special priority (RFSP/SPID value) allocated,
at MME/SGSN (or MSC if procedure added to MSC for supporting rSRVCC) usage of the UE Radio Capability Match procedure (according to TS 23.060 and TS 23.401) the eNB (or RNC) starts to apply such RRM strategy,
MME/SGSN sends SRVCC (Single Radio Voice Call Continuity) possible to eNB (or RNC), and
new indication from SGSN/MME towards the eNB (or RNC).

The RAN node might also put certain cells which support a certain service on higher priority for the UE, e.g. cells supporting rSRVCC (reverse SRVCC) on higher priority than other cells; the other cells may however still be allowed.

Such RAN node mobility strategy might ensure that a UE is able to get best possible service (i.e. allow UE to be moved using rSRVCC to a cell supporting IMS PS voice, if possible, and still allow best possible coverage even though only CS calls are possible in some cases i.e. when rSRVCC not possible).

The present invention also concerns computer programs comprising portions of software codes in order to implement the method as described above when operated by a respective processing unit of a user device and a recipient device. The computer program can be stored on a computer readable medium associated to any of the herein mentioned network nodes, e.g. a radio access network node such as an eNodeB or RNC as described above. The computer-readable medium can be a permanent or rewritable memory. The respective computer program can be also transferred to the user device for example via a cable or a wireless link as a sequence of signals.

In the following, detailed embodiments of the present invention shall be described in order to give the skilled person a full and complete understanding. However, these embodiments are illustrative and not intended to be limiting.

### BRIEF DESCRIPTION OF THE FIGURES

FIG. 1 shows an exemplary block diagram of a communication network,

FIG. 2 shows a first sequence diagram showing service based mobility sequence, wherein the RAN performs UE movement to a cell supporting a certain service, and

FIG. 3 shows a second sequence diagram showing an exemplary attachment procedure thereto.

### DETAILED DESCRIPTION

In the following, exemplary embodiments are described in more details.

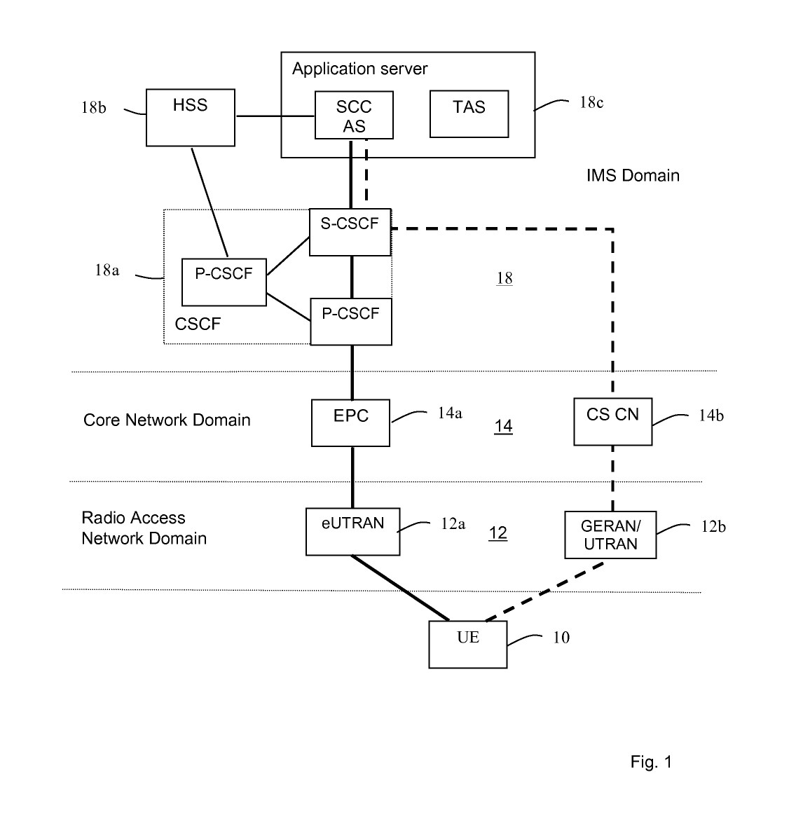

FIG. 1 shows a block diagram of an exemplary communication network comprising a UE 10, a radio access network—RAN—12, a code network—CN—14 and an IP Multimedia Subsystem—IMS—18.

The RAN by way of example comprises a evolved UMTS Terrestrial Radio Access Network—eUTRAN—12a and a legacy GSM EDGE Radio Access Network—GERAN—/UMTS Terrestrial Radio Access Network—UTRAN—12b.

The CN 14 by way of example comprises an evolved packet core network—EPS—or —EPC—, and a circuit switched code network 14b. The EPC by way of example may comprise an MME and gateway nodes (S-GW, P-GW).

The IMS 18 by way of example comprises a Call State Control Function—CSCF—18a, an HSS 18b, and an application server 18c e.g. comprising a service centralization and continuity application server—SCC AS and a telephony application server—TAS—18.

The Call State Control Function—CSCF—18a provides session control for UEs by processing SIP signaling packets in the IMS. It may comprise a P-SCSF (Proxy CSCF) node, an I-CSCF (Interrogating CSCF) node and S-CSCF (Serving CSCF) node. The P-CSCF is a SIP proxy that is the first point of contact for the terminal. Amongst other functions, this node supports a subscriber authentication and ensures that the IMS terminals do behave correctly. The S-CSCF is the central node of the signaling plane. It communicates with the HSS e.g. to get subscriber profiles. This node further handles SIP registrations, which allows it to bind the user location (e.g. the IP address of the terminal) and the SIP address. The I-CSCF is a SIP function e.g. located at the edge of an administrative domain. Its IP address is published in the Domain Name System (DNS) to be found by remote servers. Amongst other functions this node queries the HSS to retrieve the address of the S-CSCF and assign it to a user performing a SIP registration, and also forwards SIP request or response to the S-CSCF.

The HSS 18b is a database that supports the PS network entities in handling calls. It comprises subscription related information (e.g. being stored as subscriber profiles), performs authentication and authorization of the user, and might further provide information about the subscriber's location and address information (e.g. IP address). The HSS may interact with the SCC AS to inform the SCC AS e.g. about the currently used access and IMS Voice over PS support indication.

The service centralization and continuity application server—SCC AS—18c is a home network based IMS Application that provides functionality required to enable IMS Centralized Services. The SCC AS 18c may be regarded as a call control server (communicating by means of the SIP protocol) controlling a communication between the UE and a remote side (e.g. a further UE).

A first connection line (draft line) is shown from the UE 10, over the PS access network 12a, the 14a, the CSCF and the application server 18. A second connection line (dotted line) is shown from the UE 10, over the CS access network 12b, the CS core network 14b, and S-CSCF to the application server 18. The UE 10 may have a plurality of terminals or contacts having different capabilities.

According to 3GPP specifications, SRVCC provides a seamless continuity when an UE 10 performs a handover from LTE coverage (e-UTRAN) to UMTS/GSM coverage (UTRAN/GERAN). With SRVCC, calls are anchored in the IMS while UE is capable of transmitting/receiving on only one of those access networks at a given time, whereas rSRVCC enables a reverse movement from UTRAN/GERAN to e-UTRAN.

In an embodiment, a service based mobility procedure, wherein the RAN performs a UE movement to a cell supporting a certain service is described.

During mobility management (EMM or GMM) procedures, the UE is getting the information that IMS PS voice is supported for a Tracking Area list or Routing Area (referring to IMS voice over PS Session Supported Indication as specified in TS23.060 and TS 23.401), despite that the UE cannot use IMS PS voice service in certain cells of the Tracking Area list or Routing Area (the later might only be known to the eNB/RNC).

The eNB/RNC replies with successful Match when receiving the UE Radio Capability Match Request from the code network (MME or SGSN), despite that the UEs capabilities are incompatible with network configuration for the certain cells.

When the CN is requesting a bearer (e.g. QCI-1 bearer for LTE (class set to conversational and source statistic descriptor set to Speech for UTRAN) to be established, the eNB/RNC is moving (before or after the bearer has been established) the UE to a cell (served by the same or by a different eNB/RNC) supporting IMS PS voice and required capabilities.

Similar RAN node (eNB/RNC) behaviour can be applied for other services (e.g. IPTV) and consequently the trigger may be an appropriate bearer setup (other than a QCI-1 bearer for voice over IMS), or any appropriate bearer modification.

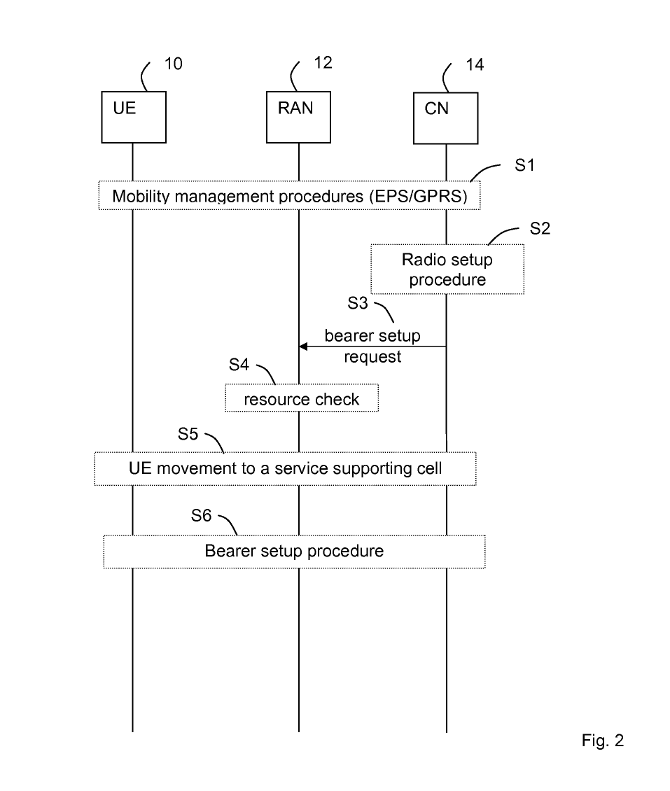

In the following an exemplary sequence is described according to FIG. 2:

1. In a first step S01, during mobility management (EMM/GMM) procedures the core network—CN—14 (e.g. MME or SGSN) indicates to the UE 10 that the certain service (IMS Voice over PS sessions, IPTV sessions etc) are possible, and RAN 12 indicates to CN 14 that UE Radio capabilities match the network configuration (e.g. according to procedures defined in 3GPP TS 23.060 and/or TS 23.401),

2. In a second step S2, CN 14 tries to setup radio resources for a certain service. Procedure used might depend on the service and whether the involved node of the CN 12 is a SGSN or a MME (e.g. according to procedures defined in 3GPP TS 23.060 and/or TS 23.401),

3. In a third step S3, CN 14 sends a bearer setup request to RAN 12.

4. In a fourth step S4, RAN 12 checks whether resources can be setup and/or if QoS (a certain QoS level) is supported. If QoS (QoS level) is not supported in the current cell, it may be checked whether the UE 10 shall be moved to a cell supporting the QoS for the service,

5. In a fifth step S5, UE 10 is moved to a cell supporting the QoS for the service, and

6. In a sixth step S6, the radio resources are setup. CN 14 may be informed about a corresponding successful bearer establishment.

Steps S5 and S6 may be performed in any order, i.e. the radio resources may be setup before, concurrently or after the UE is moved.

In another embodiment, an appropriate node of the RAN 12, e.g. a base station node such as the eNB or RNC, ensures that certain (e.g. selected) UEs always camp on cells supporting a certain service (e.g. IMS PS voice service or IPTV service).

The trigger for the RAN node to initiate such (RRM) strategy may be e.g.
special RFSP/SPID value allocated,
at MME/SGSN (or MSC if procedure added to MSC for supporting rSRVCC) usage of the UE Radio Capability Match procedure (e.g. according to procedures defined in 3GPP TS 23.060 and/or TS 23.401), the eNB/RNC starts to apply such RRM strategy,
MME/SGSN sends SRVCC possible to RNC/eNB, and/or
a new indication from SGSN/MME towards the eNB/RNC.

The RAN network node (eNB/RNC) may also put certain cells which support a certain service on higher priority for the UE, e.g. by assigning a higher priority to cells supporting (r)SRVCC than to other cells, whereby the other cells are not necessarily disallowed.

Above-described mobility strategies may ensure that the UE is able to get best possible service (i.e. allow UE to be moved using rSRVCC to a cell supporting IMS PS voice, if possible, and still allow best possible coverage even though only CS calls are possible in some cases i.e. when rSRVCC not possible).

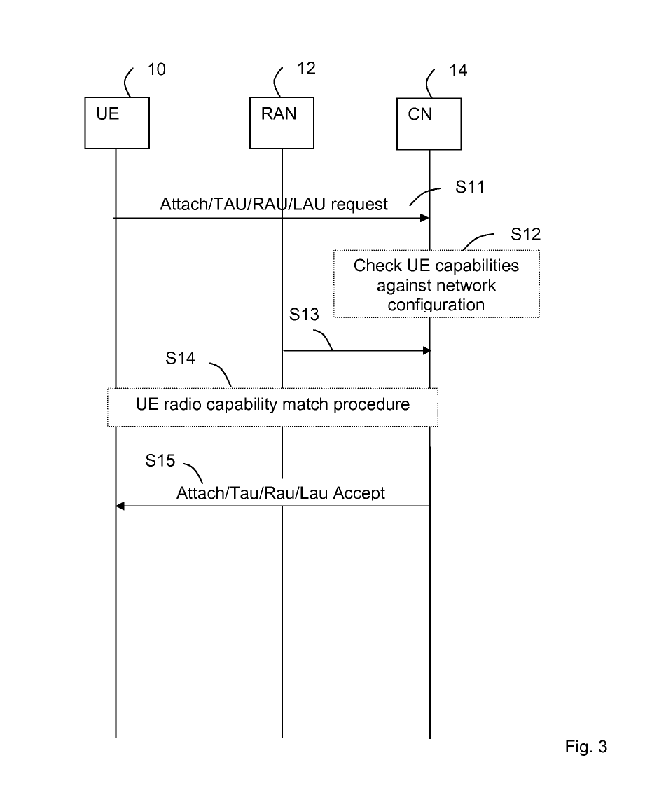

In the following an exemplary sequence is described according to FIG. 3:

1. In a first step S11 of this embodiment, the UE 10 sends Attach/TAU/TAU or LAU request to the core network CN 14 (as per existing specifications),

2. In a second step S12 of this embodiment, the CN 14 (e.g. the MME or

SGSN) invokes a UE Radio Capability Match Request procedure (e.g. according to procedures defined in 3GPP TS 23.060 and/or TS 23.401),

3. In a third step S13 of this embodiment, the RAN (e.g. eNB or RNC) perform necessary checks e.g. according to procedures defined in 3GPP TS 23.060 and/or 3GPP TS 23.401. The RAN provides a positive feedback to CN 14, and initiates applying certain mobility procedures for this UE to ensure the UE can access the wanted services (e.g. IMS PS voice). Thereto, the RAN might store a mobility strategy for this UE to be applied in appropriate procedures, e.g. the eNB sends dedicated cell re-selection information to the UE using “idleModeMobilityControlInfo” (providing dedicated cell reselection priorities) as defined in 3GPP TS 36.331, version 11.0.0. The RAN node might apply similar procedures according to this standard (the strategy might be forwarded to target RAN nodes e.g. in transparent containers, to ensure target RAN node applies same mobility strategy).

4. In a fourth step S14 of this embodiment, based on positive feedback from RAN, the CN (MME/SGSN) sends a corresponding information (e.g. sets the IMS PS Voice supported indicator to TRUE in the Attach/RAU/TAU Accept message) towards the UE (e.g. according to procedures defined in 3GPP TS 23.060 and/or TS 23.401).

5. In a fifth step S15 of this embodiment, an attach/TAU/RAU/LAU Accept message is returned from CN 14 to UE 10 (as per current specifications).

Alternatives to using the UE Radio Capability Match Request procedure as a trigger for RAN 12 to apply the specific mobility strategy for the UE 10 might be allocating Special RFSP/SPID the MME/SGSN sending SRVCC possible to RNC/eNB or sending a new indication from SGSN/MME towards the eNB/RNC as shown above.

### ABBREVIATIONS

CN Core Network
eNB evolved Node B
E-UTRAN Evolved UTRAN
EMM EPS Mobility Management
EPS Evolved Packet System
IMS IP Multimedia Subsystem
GMM/SM GPRS Mobility Management and Session Management
MME Mobility Management Entity
QCI QoS Class Identifier
QoS Quality of Service
RAN Radio Access Network
RAU Routing Area Update
RFSP RAT/Frequency Selection Priority
SPID Subscriber Profile ID
SRVCC Single Radio Voice Call Continuity
rSRVCC reverse Single Radio Voice Call Continuity
SGSN Serving GPRS Support Node
TAU Tracking Area Update
UTRAN UMTS Terrestrial Radio Access Network

1. A method of providing a certain service with respect to a user equipment (UE) in a cellular communications network, the communications network comprising a radio access network (RAN) node and a plurality of cells within an area comprising at least a first cell and a second cell, wherein at least the first cell of the plurality of cells is capable of supporting the certain service, and a core network (CN) node involved in a bearer activation process with respect to the UE, the RAN node performing the following steps:
receiving from the CN node information indicating that the UE requests the certain service, while the UE is camping on the second cell;
determining if the second cell is capable of supporting the certain service; and
as a result of determining that the second cell is not capable of supporting the certain service: sending an indication from the RAN node to the CN node indicating that UE radio capabilities match the network configuration within the area and initiating a movement to the first cell.

2. The method of claim 1, wherein receiving the information comprises receiving a bearer setup request from the core network node.

3. The method of claim 2, further comprising checking whether the radio resources according to the bearer setup request can be setup in the current cell, and initiating the movement of the UE to the first cell in case that the radio resources cannot be setup.

4. The method of claim 1, wherein initiating the movement to the first cell comprises initiating a cell handover or a relocation process such that a camping with respect to the UE is changed from the second cell to the first cell.

5. The method of claim 1, further comprising establishing the radio resources involving the first cell according to the bearer setup request, and sending a corresponding information message to the core network node.

6. The method of claim 1, further comprising:
receiving from the CN node a capability match request,
providing a positive feedback to the CN node so that the CN node sends a corresponding information towards the UE, and
initiating applying certain mobility procedures for this UE to ensure that the UE can access the service requested by the UE.

7. The method of claim 6, wherein the corresponding information sent towards the UE comprises a service support indicator set to TRUE in an Attach/RAU/TAU Accept message.

8. The method of claim 7, wherein the RAN node keeps stores a mobility strategy for this UE to be applied in appropriate procedures.

9. The method of claim 1, wherein the CN node is one of:
a Mobility Management Entity and a Serving GPRS Support Node.

10. The method of claim 1, wherein the RAN node is one of: an evolved Node B, a radio network controller and a base station controller.

11. The method of claim 1, wherein the certain service is anyone of: a voice service over PS, a voice service over IMS, IMS PS voice, SRVCC, rSRVCC, and IPTV.

12. A radio access network (RAN) node operable within a communications network comprising a plurality of cells within an area comprising at least a first cell and a second cell, wherein at least the first cell of the plurality of cells is capable of supporting a certain service, and a core network (CN) node involved in a bearer activation process with respect to the UE, comprising:
a receiver for receiving from the CN node information indicating that the UE requests the certain service, while the UE is camping on the second cell;
a processor for: determining that the second cell is not capable of supporting the certain service, generating an indication that UE radio capabilities match the network configuration within the area, and initiating a movement to the first cell; and
a transmitter for sending the indication from the RAN node to the CN node.

13. A computer program product comprising a non-transitory computer readable medium storing a computer program loadable into a processing unit of a radio access network node, the computer program comprising code adapted to cause the processing unit to perform the steps of claim 1.
